(19) United States
(12) Patent Application Publication
(10) Pub. No.: US 2019/0023191 A1
(43) Pub. Date: Jan. 24, 2019

(54) ELECTRONIC STORAGE BOX FOR VEHICLES

(71) Applicant: Westin Automotive Products, Inc., San Dimas, CA (US)

(72) Inventor: Carlos Rios, Mira Loma, CA (US)

(21) Appl. No.: 15/652,394

(22) Filed: Jul. 18, 2017

(51) Int. Cl. B60R 11/02

(52) U.S. Cl. CPC B60R 11/02; B60R 2011/0036

(57) ABSTRACT

The present invention provides an electronic box for a vehicle comprising: a storage housing having at least two tray brackets and a front aperture; a removable tray having (a) a channel having channel slots; (b) at least one engagement member that fits into the channel and (c) at least one latch mechanism; wherein (i) a tray slot is included in each of the at least two tray brackets; (ii) the at least one engagement member engages with the tray slots via the channel slots thereby forming a hinged mechanism when the electronic box in a closed configuration; and (iii) the at least one engagement member disengages with the tray slots when the electronic box is an opened configuration and allows the removable tray to open via the front aperture. The present invention also provides a method for attaching the above-described electronic box to a vehicle.

### FIELD OF INVENTION

The present invention relates to vehicle accessory field. More specifically, it relates to an electronic storage box for vehicles, especially public safety vehicles.

### BACKGROUND OF INVENTION

Many public safety vehicles today are conventional sport utility vehicles (“SUVs”) modified with additional electronics and other equipment such as radios, sirens, fuse blocks, relays, computers or the like (collectively hereinafter referred to as “public safety devices” or “PSV devices”) in order to meet the needs of public safety officers (e.g., police). PSV devices are usually stored in the vehicle's cargo area by directly attached to the partition between the rear passenger seats and the cargo area. This direct attachment method not only leaves the PSV devices exposed but makes testing and serving the PSV devices less convenient. PSV devices are also known to be attached to a fixed tray of a storage container located within the cargo area. While this method offers more protection for the PSV devices, it is still less convenient to test and service them. Moreover, some of these storage containers use the vehicle space normally set aside for spare tire storage thereby leaving no available space for storing the spare tire.

### BRIEF DESCRIPTION OF THE DRAWING

The present invention will be more clearly understood when considering the accompanying drawing of which:

FIG. 1 shows a front prospective view of an electronic box in accordance with the present invention in a closed configuration;

FIG. 2 shows a front view of the electronic box of FIG. 1 attached to and stored within a SUV's cargo area;

FIG. 3 shows a rear prospective view of the electronic box of FIG. 1 in a closed configuration;

FIG. 4 shows a front prospective view of the electronic box of FIG. 1 in an open configuration with its tray opened and pulled down wherein PCV devices are attached to the top of the tray;

FIG. 5 shows a cross-sectional prospective view of the electronic box of FIG. 1 in a closed configuration;

FIG. 6 shows a cross-sectional exploded view of the electronic box of FIG. 1 in an opened configuration with its tray and member removed;

FIG. 7 shows a cross-sectional view of a portion of the electronic box of FIG. 1 in a closed configuration;

FIG. 8 shows a cross-sectional view of the portion of the electronic box shown in FIG. 7 wherein the tray is in the process of being pulled down;

FIG. 9 shows a cross-sectional view of the portion of the electronic box shown in FIG. 7 wherein the tray is pulled down causing the electronic box to be in an opened configuration;

FIG. 10 shows a cross-sectional view of the portion of the electronic box shown in FIG. 7 wherein the tray is unhinged and removed from the electronic box;

FIG. 11 shows a rear prospective view of a portion of the electronic box shown in FIG. 7 but with an alternative embodiment of the removable tray;

FIG. 12 shows a front prospective view of the electronic box of FIG. 11 in a closed configuration;

FIG. 13 shows a front prospective view of the electronic box of FIG. 11 in an open configuration; and

FIG. 14 shows a cross sectional view of a tray of the electronic box of FIG. 11.

### DESCRIPTION OF THE PREFERRED EMBODIMENT

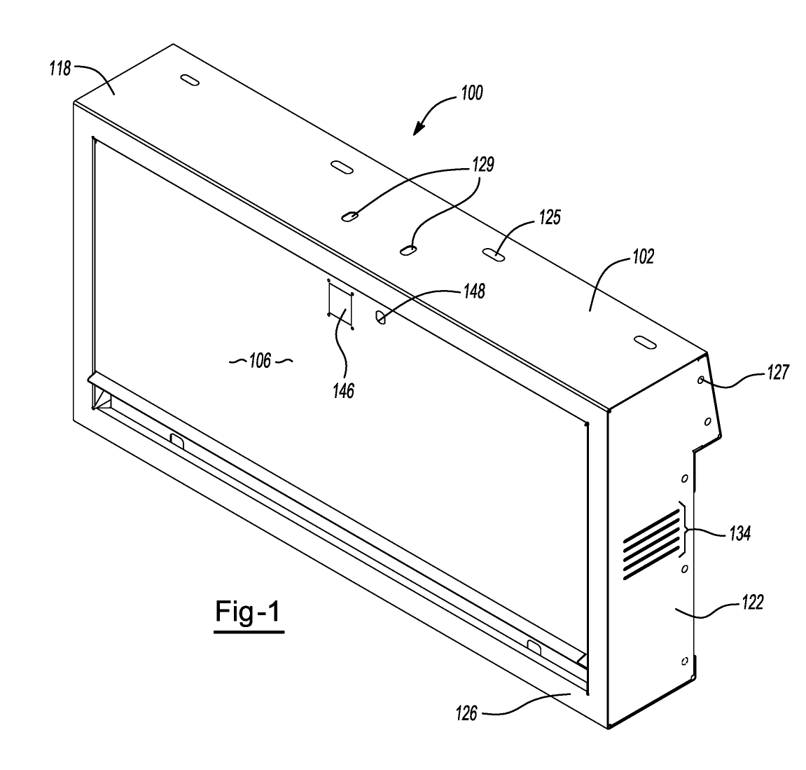

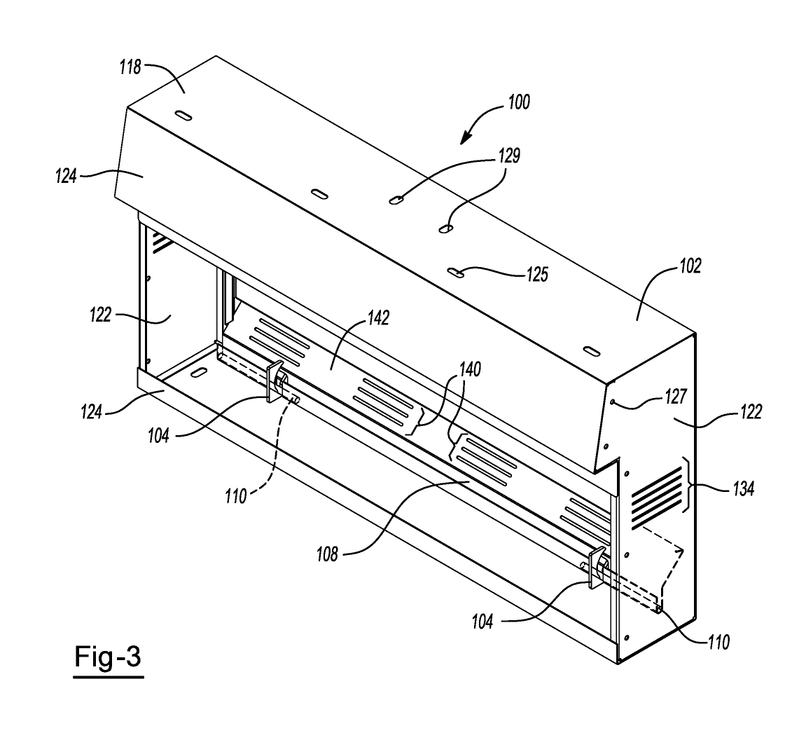

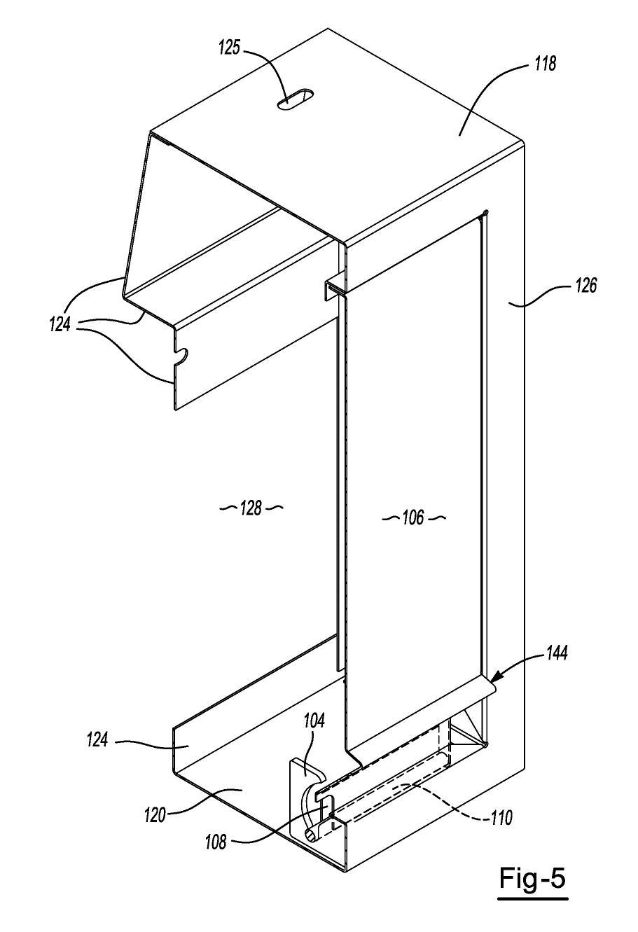

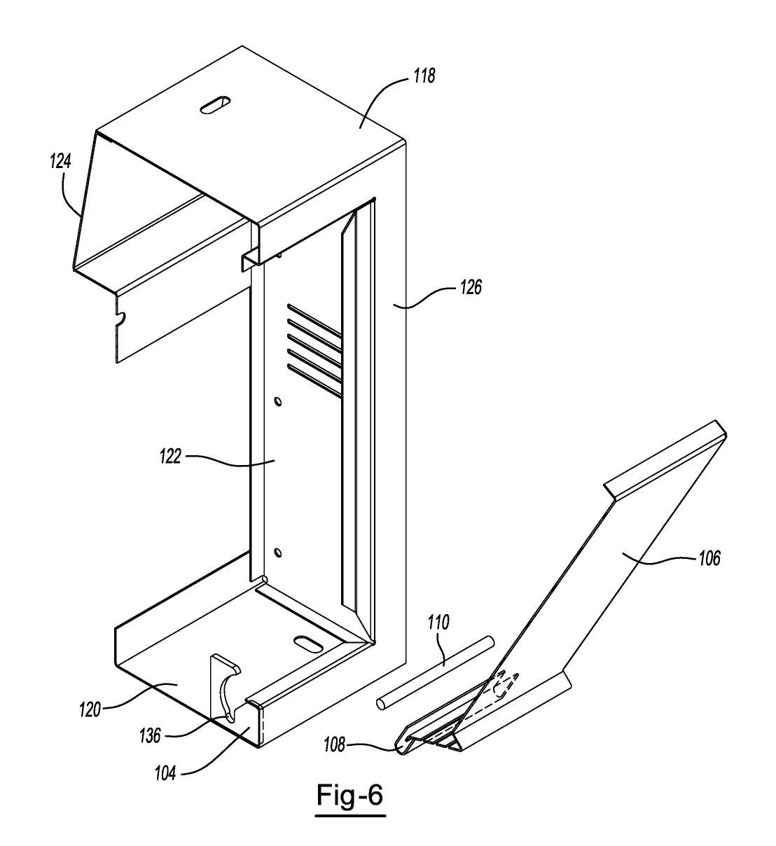

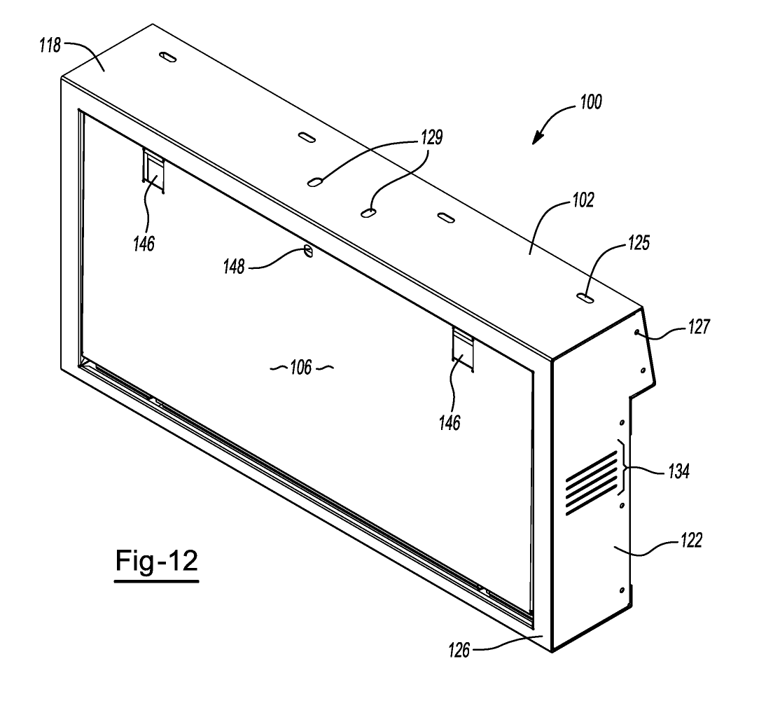

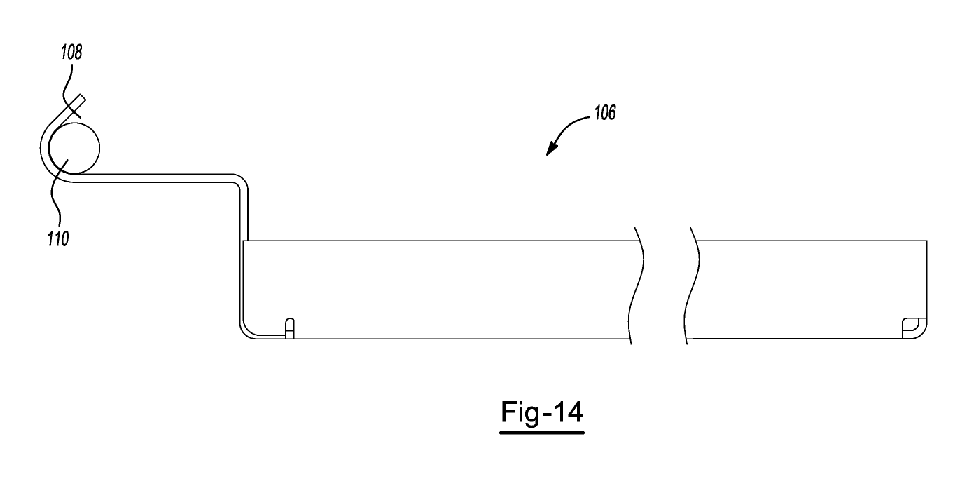

The present invention of an electronic box with a removable hinged tray for storing and attaching PSV devices. This invention not only provides protection for the PSV devices, but also offers a convenient way to test and service the PSV devices because the tray can be easily removed with all of the PSV devices still fixedly attached to the tray. Referring to FIGS. 1-14 showing an embodiment of an electronic box 100 of the present invention comprising a storage housing 102 having at least two tray brackets 104, a removable tray 106 having a channel 108 and at least one engagement member 110 (e.g., a rod or the like) that fits into the channel 108 and engages with the at least two tray brackets 104 through/via the channel slots 138 as shown in FIGS. 3-5, 11 and 13. The at least one engagement member 110 is preferably fixedly located within the channel (e.g., welded or the like) at the predetermined position.

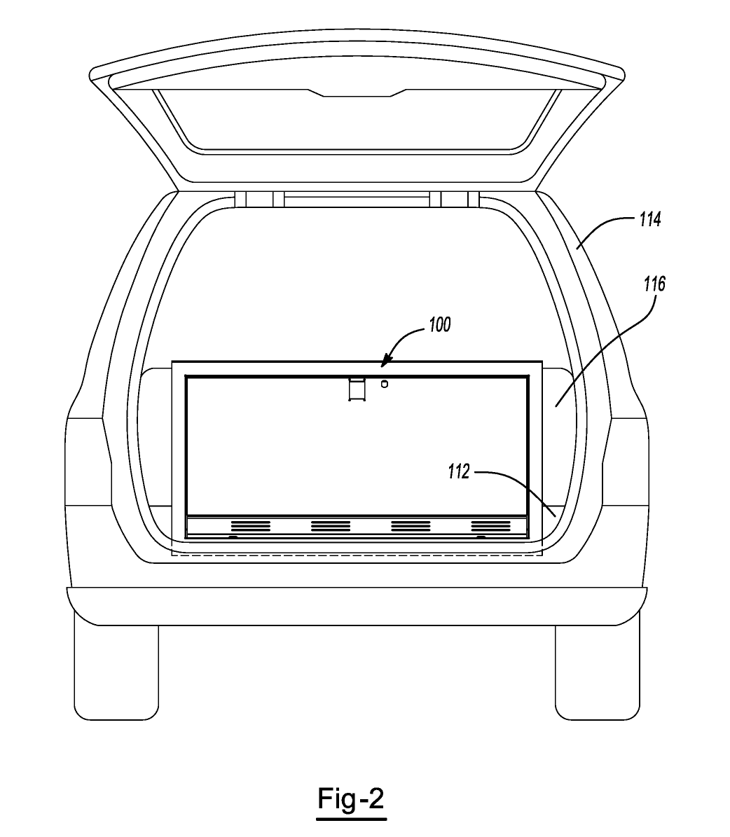

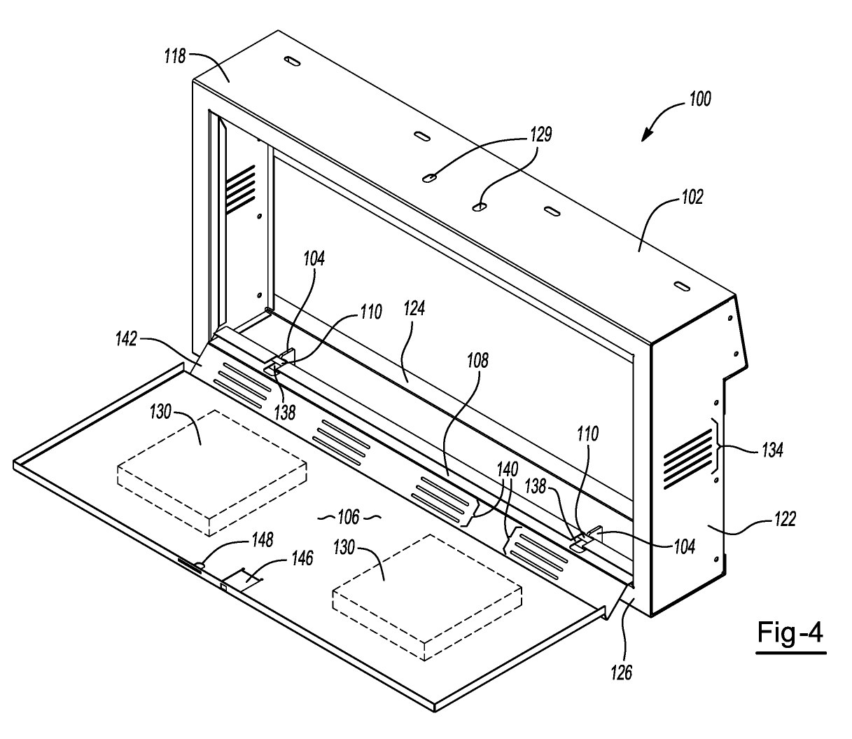

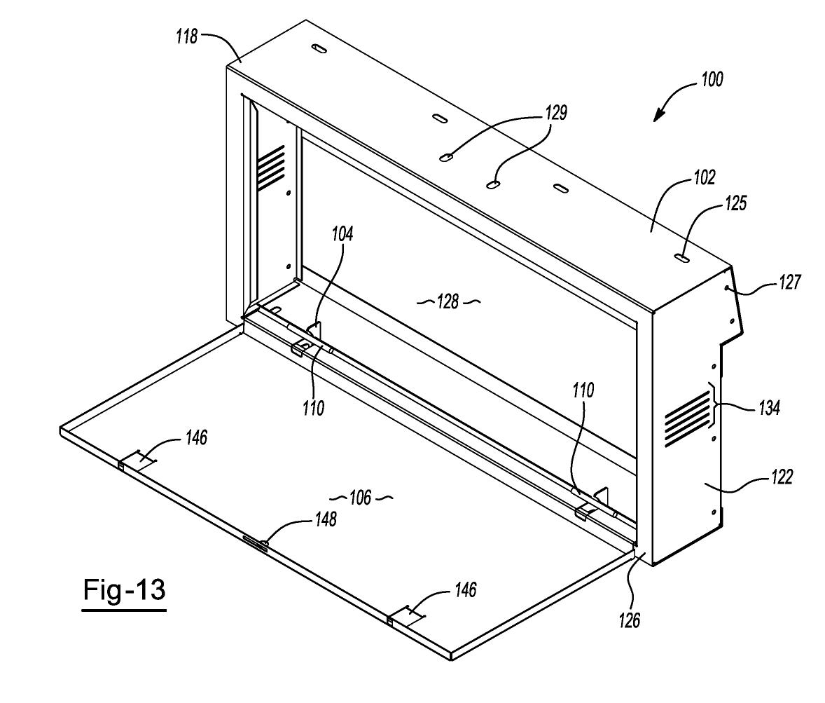

The storage housing 102 fits into the cargo area 112 of a vehicle such as a sport utility vehicle (“SUV”) 114 and is preferably attached to the rear partition or seat(s) (hereinafter collectively referred to as “rear partition”) 116 of the SUV 114 as shown in FIG. 1. Referring to FIGS. 2-6 and 12-13, the housing 102 includes a top panel 118, a bottom panel 120, side panels 122, a rear panel 124, and a front panel 126. The rear panel 124 may optionally (i) shaped to conform to the rear partition 116 and/or (ii) include a rear aperture 128 as shown in FIGS. 2, 5 and 13. The rear aperture 128 allows the rear partition 116 to form a part of the rear portion of the electronic box 100 which, depending upon the design of the rear partition 116, may allow access and wire/cable connections to the interior of the electronic box 100 and the PVC devices 130 stored within the electronic box 100. The front panel 126 also includes a front aperture 132 which provides access to the interior of the electronic box 100 when the electronic box is in an opened configuration (e.g., when the tray 106 is pulled down and/or removed from the electronic box 100) as shown in FIGS. 4 and 13. It is optional that any one of the panels (e.g., 118, 120, 122, 124 and 126) of the housing 102 includes slots 134 in order to provide additional ventilation for the PSV devices 130. It is also optional that one or more of these panels (e.g., 118, 120, 122, 122, 124 and 126) of the housing 102 includes apertures for a screen guard partition 125, seat belts 129, and/or for additional attachment means 127 (e.g., brackets for holding devices outside of the electronic box 100 or the like).

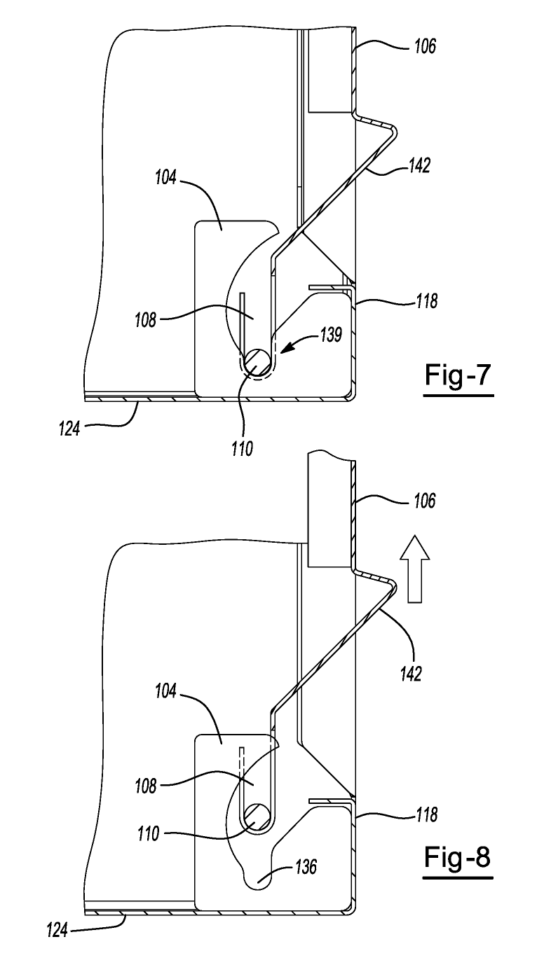

Referring to FIGS. 2, 5 and 13, the at least two tray brackets 104 are connected to the bottom panel 120 and the front panel 126. Each of the brackets 104 includes a tray slot 136 that accepts and engages the at least one engagement member 110 in order to form a hinged mechanism 139 when (i) the tray 106 is attached to the electronic box 100 and (ii) the electronic box is in a closed configuration as shown in FIG. 7. The at least one member 110 is situated within the channel 108 and engages with each of the tray slots through the channel slots 138 as shown in FIGS. 3-5, 11 and 13.

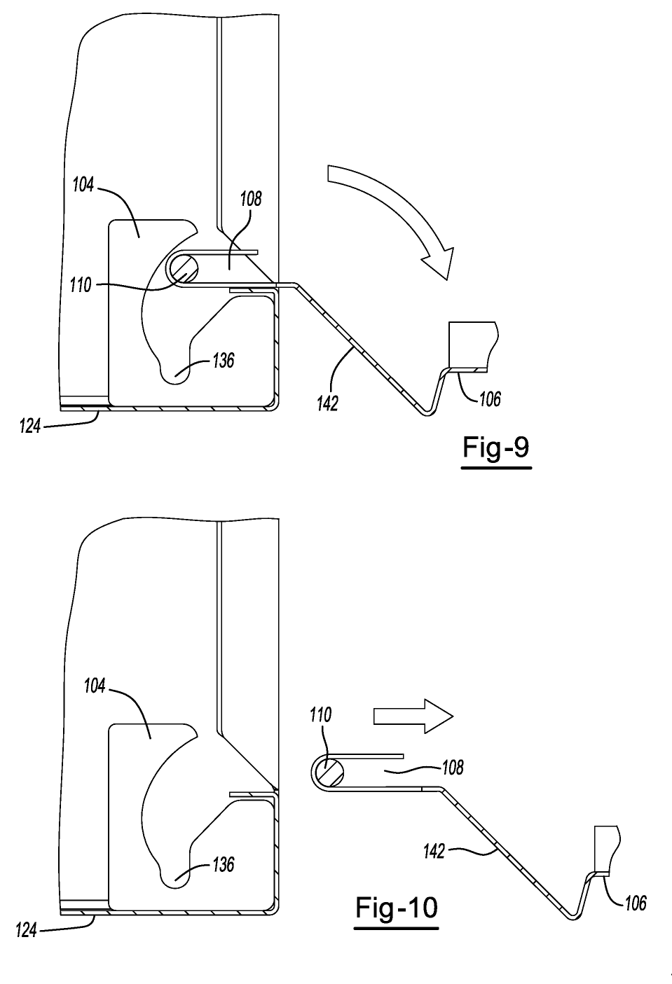

Referring to FIG. 7-9, the electronic box 100 can be converted into an opened configuration from a closed configuration (as shown in FIG. 7) when (i) the tray 106 is first lifted in an upward motion (shown in FIG. 8) causing the portion 124 of the channel 108 to disengage from the tray slot 136; and (ii) the tray 106 is then pulled in a downward motion (as shown in FIG. 9). Once the tray 106 has been pulled downward and resting on the front panel 126 and/or one of the brackets 104, the PVC devices 130 are now accessible. However, the PVC devices 130 can also be removed from the electronic box 100 and/or the cargo area 112 if desired by pulling the tray 106 in an outward motion as shown in FIG. 10 in order to detach the tray 106 from the electronic box 100. If desired, one can also detach any wires/cables connected to the PVC devices 130.

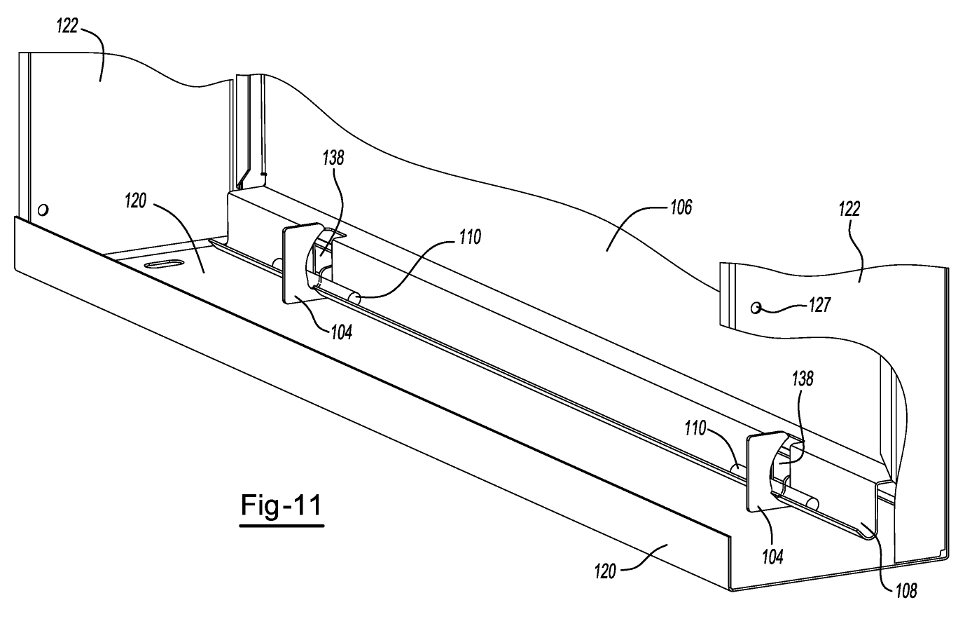

Referring to FIG. 2, the tray 106 optionally includes tray ventilation slots 140 in order to provide additional ventilation for the PSV devices 130. Furthermore, it is also optional that the tray 106 includes a sloped portion 142 as shown in FIGS. 3, 9-10. The sloped portion 142 connects the channel 108 to other portion(s) of the tray 106. The sloped portion 142 allows the tray 106 to physically contact and rest upon the cargo area 112 with its contact portion 144 as shown in FIGS. 9-10. It is optional that the ventilation slots 140 are located within the sloped portion 142. Alternatively, the tray 106 can be constructed without the tray ventilation slots 140 and the sloped portion 142 as shown in FIGS. 11-14.

Referring to FIGS. 1, 3, and 12-13 the tray 106 further includes at least one latch mechanism 146 that opens and closes the tray 106. The tray 106 may also include an optional lock 148 that unlocks and locks the latch mechanism 146.

The above-described components of the electronic box 100 may be constructed out of any suitable art-disclosed material. Examples of such material are steel including but are not limited to stainless steel, cold rolled steel, mild steel, high strength steel, tempered steel, aluminum, and other metal alloys. The thickness of each individual component may vary. Examples of suitable thickness are in the range from about 1/16″ to about ½″ and from about 1 mm to about 6 mm.

The exact size and shape of the electronic box 100 may vary depending on the vehicle 114.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The present invention also includes a method for attaching the electronic box 100 to the vehicle 114 comprising: providing the electronic box 100 and attaching the electronic box 100 to cargo area 112 of the vehicle 114 by securing the electronic box 100 to at least one surface of the cargo area 112 in a fashion that allows the tray 106 to open toward rear opening of the vehicle 114 as shown in FIG. 2.

What is claimed is:

1. An electronic box for a vehicle comprising:
a storage housing having at least two tray brackets and a front aperture;
a removable tray having (a) a channel having channel slots; (b) at least one engagement member that fits into the channel and (c) at least one latch mechanism;
wherein
(i) a tray slot is included in each of the at least two tray brackets;
(ii) the at least one engagement member engages with the tray slots via the channel slots thereby forming a hinged mechanism when the electronic box in a closed configuration; and
(iii) the at least one engagement member disengages with the tray slots when the electronic box is an opened configuration and allows the removable tray to open via the front aperture.

2. The electronic box of claim 1 wherein each of the at least one engagement member is welded to the channel.

3. The electronic box of claim 1 wherein (i) the removable tray has two engagement members and two channel slots; and (ii) each of the engagement members are welded at predetermine locations to the channel.

4. The electronic box of claim 1 wherein the storage housing includes a rear aperture.

5. The electronic box of claim 1 wherein the storage housing includes ventilation slots.

6. The electronic box of claim 1 further comprising a lock that locks and unlocks the at least one latch mechanism.

7. The electronic box of claim 1 wherein the storage housing further includes attachment means for attaching a screen guard partition.

8. The electronic box of claim 1 wherein the storage housing further includes attachment means for attaching seat belts.

9. The electronic box of claim 1 wherein the storage housing further includes attachment means for attaching of one or more brackets to exterior of the storage housing.

10. A method for attaching an electronic box to a vehicle comprising:
a. providing an electronic box for a vehicle comprising: a storage housing having at least two tray brackets and a front aperture; a removable tray having (i) a channel having channel slots, (ii) at least one engagement member that fits into the channel, and (iii) at least one latch mechanism; wherein a tray slot is included in each of the at least two tray brackets; the at least one engagement member engages with the tray slots via the channel slots thereby forming a hinged mechanism when the electronic box in a closed configuration; and the at least one engagement member disengages with the tray slots when the electronic box is an opened configuration and allows the removable tray to open via the front aperture; and
b. attaching the electronic box to cargo area of the vehicle by securing the electronic box to at least one surface of the cargo area in a fashion that allows the tray to open toward rear opening of the vehicle.

11. The method of claim 10 wherein each of the at least one engagement member is welded to the channel.

12. The method of claim 10 wherein (i) the removable tray has two engagement members and two channel slots; and (ii) each of the engagement members are welded at predetermine locations to the channel.

13. The method of claim 10 wherein the storage housing includes a rear aperture.

14. The method of claim 10 wherein the storage housing includes ventilation slots.

15. The method of claim 10 further comprising a lock that locks and unlocks the at least one latch mechanism.

16. The method of claim 10 wherein the storage housing further includes attachment means for attaching a screen guard partition.

17. The method of claim 10 wherein the storage housing further includes attachment means for attaching seat belts.

18. The method of claim 10 wherein the storage housing further includes attachment means for attaching of one or more brackets to exterior of the storage housing.

19. The method of claim 10 wherein public safety devices are attached to the removable tray.

20. An electronic box for a vehicle comprising: a storage housing having two tray brackets and a front aperture, and a removable tray having (a) a channel having channel slots; (b) two engagement members that fit into the channel and (c) at least one latch mechanism; wherein
(i) a tray slot is included in each of the two tray brackets;
(ii) each of the two engagement members engages with one of the two tray slots via one of the channel slots thereby forming a hinged mechanism when the electronic box in a closed configuration;
(iii) the two engagement members disengage with the tray slots when the electronic box is an opened configuration and allows the removable tray to open via the front aperture;
(iv) each of the two engagement members are welded at predetermine locations to the channel; and
(v) the storage housing includes a rear aperture, ventilation slots, and a lock that locks and unlocks the at least one latch mechanism.
